(19) United States
(12) Patent Application Publication
(10) Pub. No.: US 2010/0294707 A1
(43) Pub. Date: Nov. 25, 2010

(54) MULTI-STAGE FILTER CARTRIDGE WITH SNAP FIT FILTERS

(75) Inventors: Wassem Abdalla, Quimper (FR); Ricky England, Sparta, TN (US); Sainath R. Racha, Cookeville, TN (US); Eric R. Burgan, Baxter, TN (US); Jeffrey A. Husband, Cookeville, TN (US)

Correspondence Address: HAMRE, SCHUMANN, MUELLER & LARSON, P.C., P.O. BOX 2902, MINNEAPOLIS, MN, 55402-0902, US

(73) Assignee: Cummins Filtration IP Inc., Minneapolis, MN (US)

(21) Appl. No.: 12/470,271

(22) Filed: May 21, 2009

(51) Int. Cl. B01D 25/164; B01D 25/176; B01D 25/19

(52) U.S. Cl. 210/227; 210/228; 210/229

(57) ABSTRACT

A filter cartridge is described that is designed to accommodate multi-stage filtration, for example dual stage filtration. A filter cartridge includes an outer filter with an endplate and an inner filter arranged within the central axis of the outer filter and that includes an endplate. The endplate of the outer filter includes an outer portion and an inner portion substantially surrounded by the outer portion. The inner portion is axially positioned relative to the outer portion and distal to the inner and outer filters relative to the outer portion. The inner portion includes an upwardly extending flange. The endplate of the inner filter includes a downwardly extending flange. The endplates of the outer and inner filters are arranged in a snap fit connection through engagement of the upwardly extending and the downwardly extending flanges. The endplate structure can provide a filter cartridge with filters of generally equal lengths.

### FIELD

This disclosure generally pertains to the field of filtration, and more particularly to a filter cartridge for dual stage filtration and having snap-fitting endplates.

### BACKGROUND

Filter cartridges are used in a number of different technologies to filter a fluid. The use of filter cartridges to filter fluids such as air, fuel, oil and other fluids is well known. Filter cartridges can be constructed with a single filter media, or with multiple filter media, for example as a dual stage (e.g. filter-in-filter) filter design that uses an inner filter media disposed inside of an outer filter media. A filter-in-filter design can provide a high particle filtration efficiency and high fuel/water separation through a wide range of fuel interfacial values. Such filter cartridges can include one or more filter media and endplates secured to the filter media at opposite ends. In some cases of a filter cartridge configured as a filter-in-filter construction, the inner and outer filter media can have different lengths.

Improvements may be made to such known filter cartridges, such as improvements in their assembly and seal construction for example in dual stage (e.g. filter-in-filter) filter applications.

### SUMMARY

Generally, a filter cartridge is described that is designed to accommodate multi-stage filtration, for example dual stage filtration. A filter cartridge herein has a design with an inner filter and an outer filter. In one embodiment, the inner and outer filters, particularly the bottom endplates, are engaged to each other via a snap fit connection. During manufacture, for example, the inner filter can be inserted into the outer filter, where the snap fit connection retains the inner filter in the outer filter.

In one embodiment, a filter cartridge includes an outer filter with an endplate and an inner filter arranged within the central axis of the outer filter and that includes an endplate. The endplate of the outer filter includes an outer portion and an inner portion substantially surrounded by the outer portion. The inner portion is axially positioned relative to the outer portion and distal to the inner and outer filters relative to the outer portion. The inner portion includes an upwardly extending flange. The endplate of the inner filter includes a downwardly extending flange. The endplates of the outer and inner filters are arranged in a snap fit connection through engagement of the upwardly extending and the downwardly extending flanges.

In one embodiment, the endplate structure provides a filter cartridge that can accommodate filters of generally equal lengths. For example, the outer filter and the inner filter have bottom ends that reside on substantially the same plane with respect to the central axis. In other examples the inner and outer filters have substantially the same height from end to end.

### BRIEF DESCRIPTION OF THE DRAWINGS

FIG. 1 is a sectional view of a filter cartridge according to one embodiment and installed in a filter housing, and showing one embodiment of an endplate structure for an inner filter and an outer filter.

FIG. 2 is a perspective view of a filter cartridge removed from the filter housing.

FIG. 3 is a sectional view of the filter cartridge of FIG. 2.

FIG. 4 is a top perspective view of another embodiment of an endplate for an outer filter.

FIG. 5 is a bottom perspective view of the endplate of FIG. 4.

FIG. 6 is a top perspective of one embodiment of an endplate for an inner filter.

FIG. 7 is sectional view of the endplate of FIG. 6.

FIG. 8A is one embodiment of a seal configuration for sealing an endplate of an inner filter with a standpipe of a housing.

FIG. 8B is another embodiment of a seal configuration for sealing an endplate of an inner filter with a standpipe of a housing.

FIG. 8C is another embodiment of a seal configuration for sealing an endplate of an inner filter with a standpipe of a housing.

FIG. 8D is yet another embodiment of a seal configuration for sealing an endplate of an inner filter with a standpipe of a housing.

### DETAILED DESCRIPTION

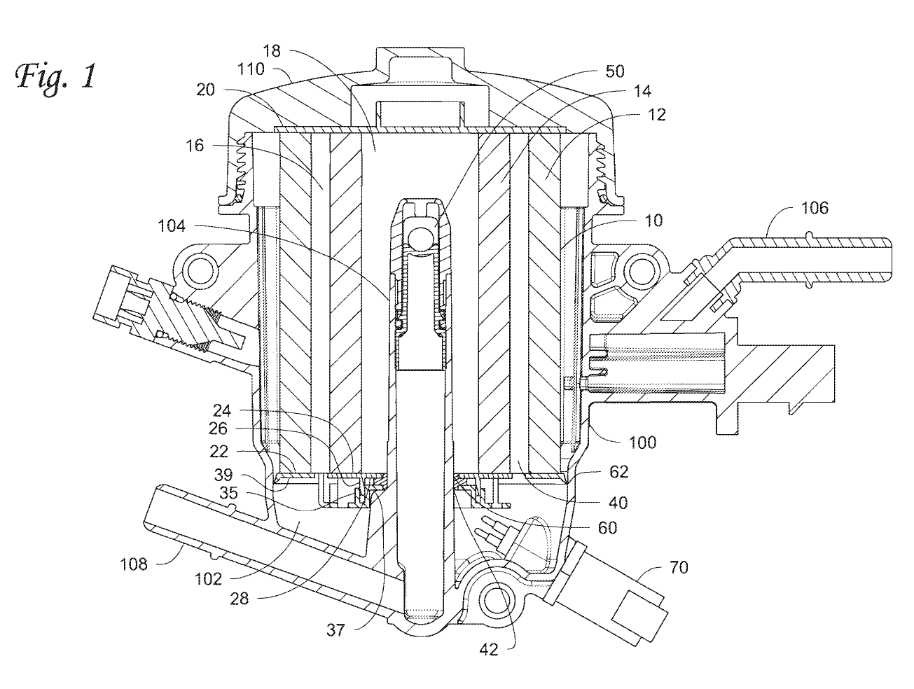

With reference to FIG. 1, a filter cartridge 10 according to one embodiment is illustrated. The filter cartridge 10 is designed to be installed in a filter housing 100 for filtering a liquid, for example diesel fuel, and removing water from the liquid. This description hereinafter describes the liquid as fuel. However, it is to be realized that the concepts described herein can be used for other liquids. In appropriate circumstances, the concepts described herein also can be used to remove contaminants other than water from the liquid. And, in appropriate circumstances, the concepts described herein can be used on filter cartridges that filter other types of fluids, for example air, oil and other fluids that can benefit from a filtration system. This description also describes the filter cartridge as a filter-in-filter design with first and second filter media. However, it is to be appreciated that the concepts herein can be used for any multistage filtration that may have more than two filter media.

As shown in FIG. 1, the filter cartridge 10 is of filter-in-filter construction including an outer filter 12 and an inner filter 14 concentrically arranged. In the embodiment shown, the cartridge 10 is designed for outside-in flow, with fuel entering the cartridge 10 from the outside and flows inwardly to the inside of the cartridge 10.

The outer filter 12 includes a first generally circular filter media 16 disposed around a central axis. The inner filter 14 includes a second generally circular filter media 18 with an inner diameter defining a generally open area. The filter media 16 and 18 may be composed of various materials and configurations as known in the art. For example, the filter media 16, 18 may be configured as a pleated structure, a chevron pleated structure, or as depth media and be made of paper-like or other fibrous material as known in art. It also will be appreciated that the outer filter 12 and the inner filter 14 may be constructed with center tubes such as known in the art to provide additional stability for the filters 12, 14.

As shown, the inner filter 14 is arranged within the central axis of the outer filter 12, such that there is a space 40 between an inner diameter of the outer filter 12 and an outer diameter of the inner filter 14. The generally open area of the inner filter 14 is receivable of a standpipe 104 of a filter housing.

In the embodiment of FIG. 1, an endplate 20 is on a top end of each of the outer filter 12 and the inner filter 14. It will be appreciated that the outer filter 12 and the inner filter 14 can each have an endplate at their respective top end, such as may be known in the art.

The outer filter 12 and the inner filter 14 also have an endplate structure on a bottom end of each of the outer filter 12 and the inner filter 14. The endplates are configured to be assembled in a snap fit connection, and can be of a plastic material for example.

As shown, one endplate 24 is on the bottom of the outer filter 12 and another endplate 22 is on the bottom of the inner filter 14.

With further reference to the snap fit connection between the endplates 22, 24, FIG. 1 generally shows one embodiment of the snap fit connection through upwardly extending and downwardly extending flanges 35, 26 (discussed below).

The endplate 24 has an outer portion 39 attached to the first filter media 16, and an inner portion 37 substantially surrounded by the outer portion 37. The endplate 24 includes at least one opening between the outer portion 39 and the inner portion 37 in fluid communication with the space 40 between the outer filter 12 and the inner filter 14. The endplate 24 further includes that the inner portion 39 is axially positioned relative to the outer portion 39, such that it is distal to the inner filter 14 and the outer filter 12 relative to the outer portion 29. That is, in the view shown the inner portion 37 is recessed or lower than the outer portion 39. The inner portion 37 further includes an upwardly extending flange 35 that extends toward the filter media 18. As shown, the upwardly extending flange 35 also is axially positioned, so that it is distal to the inner filter 14 and outer filter 12 relative to the outer portion 39.

Turning to the endplate 22, the endplate 22 has a segment 28 where the opening 42 extends therethrough. The opening 42 is in fluid communication with the open area of the inner filter 14, which is defined by the inner diameter of the inner filter 14. The opening 42 as illustrated is generally circular in shape for fitting around a generally circular standpipe (e.g. standpipe 104). However, the opening 42 could have other shapes as well for example oval, so as to fit around for example an oval standpipe.

The endplate 22 further includes a downwardly extending flange 26 surrounding the opening 42. With further reference to the snap fit connection, the endplates 22, 24, as shown are arranged to be engaged to retain the outer filter 12 and inner filter 14 together through the upwardly extending flange 35 and the downwardly extending flange 28. For example, one of the upwardly extending flange 35 and the downwardly extending flange 28 can have a larger or smaller diameter relative to the other of the upwardly extending flange 35 and the downwardly extending flange 28. When connected, either directly or indirectly, the flanges 35, 28 are fitted together in a snapping configuration.

In such an endplate structure as shown, the recessed or axially distal arrangement of the inner portion 37 relative to the outer portion 39 provides a configuration, so that the bottom of the outer filter 12 and the inner filter 14 can reside on substantially the same plane. For example, the bottom of the outer filter 12 and the inner filter 14 are on the same plane with respect to the central axis of the outer filter 12. In some embodiments, such as shown in FIG. 1, the outer filter 12 and the inner filter 14 have the same height from the top end to the bottom end. Having the inner filter 14 with at least the same height as the outer filter 12 can provide an overall more efficient filter assembly and that can exploit the most filtration capability from the outer filter 12.

As to sealing structures, the endplate 24 includes an outer sealing surface 62 on an outer diameter of the outer filter 12, and the endplate 22 includes an inner sealing surface 60 on the inner diameter of the inner filter 14. As shown in FIG. 1, for example, the outer sealing surface 62 seals with the inner surface of a filter housing, for example housing 100. The outer sealing surface 62 keeps incoming fuel that has entered through the inlet 106 separated from water that has collected in the sump 102. The inner sealing surface 60 seals with the outer surface of the standpipe 104. The inner sealing surface 60 keeps filtered fuel separated from fuel that has yet to pass the inner filter 14.

With further reference to the outer sealing surface 62, the surface in the embodiment shown is a wiper flange or lip disposed at the outer peripheral edge of the outer portion 39. The flange extends downwardly therefrom at an angle away from the outer peripheral edge of the outer portion 39. In one embodiment, the flange is generally circular and is integrally formed with the outer portion 39, although the flange could be non-integrally formed. When the filter cartridge 10 is installed, the flange seals with the interior surface of the housing 100 as shown in FIG. 1. The outer sealing surface 62 is not meant to be limited to the flange or lip shown. Instead of the flange or in addition to the flange, if found to be acceptable, a gasket, for example an o-ring or an overmold gasket, can be provided as the outer sealing surface 62 for sealing with the interior of the housing 100.

With further reference to the inner sealing surface 60, the inner sealing surface 60 in some cases is any suitable gasket. In the embodiment shown, the inner sealing surface 60 is a gasket that is retained in a groove between the inner portion 37 of the endplate 24 and the segment 28 of the endplate 22. The gasket is shown to partially overlap the annular corners of the inner portion 37 and the segment 28.

As an example of how the filter cartridge is used, the filter cartridge 10 is installed into the filter housing 100 as part of a filter assembly. As shown, the filter housing 100 is designed to receive the filter cartridge 10 therein for filtering the fluid. The filter housing 100 includes a side wall and an end wall that define a filter cartridge space large enough to receive the filter cartridge 10 therein, with the end wall forming a generally closed end around the standpipe 104. The housing 100 has an open end generally opposite the end wall and that can be closed by a lid 110. The housing 100 includes an inlet opening 106 through which fuel to be filtered enters the housing 100. An outlet 108 extends from the end wall of the housing 100. The outlet 108 is in fluid communication with the standpipe 104, through which fuel exits on its way to a protected system such as the engine (not shown). It is to be realized that the housing 100 could have other configurations than that illustrated by FIG. 1.

With further reference to the standpipe 104, the standpipe 104 is secured to the end wall and extends upwardly into the generally open space of the housing 100 toward the open end and the lid 110. In the illustrated embodiment, the standpipe 104 is generally hollow from its end connected to the end wall to a tip end thereof, thereby defining an internal flow passage. The flow passage is in communication with the outlet 108 so that fuel that enters the standpipe 104 can flow from the standpipe 104 through the outlet 108 and to the engine. As shown, the standpipe 104 is centered within the housing 100. In some embodiments, the standpipe 104 may be in an off-center position.

The filter assembly illustrated in the embodiment of FIG. 1 also shows a flow restriction valve 50 disposed at the tip end of the standpipe 104. It will be appreciated that the filter cartridge concepts described herein can be used with filter assemblies that do not use flow restriction valves. The flow restriction valve, when used, controls the flow of fuel into the standpipe 104. Flow restriction valves are known and are used to prevent fuel flow into a standpipe, such as when the filter cartridge is not installed or when an incorrect filter cartridge is installed. When the filter cartridge or other appropriately designed filter cartridge is installed, filter cartridges herein can be designed to interact with the valve in such a manner as to keep the valve from preventing fuel flow into the standpipe. An example of a valve operating in this manner is disclosed in U.S. Pat. No. 6,884,349 and in U.S. patent application Ser. No. 11/780,176. In some cases, the top endplate (e.g. endplate 20) includes various activating structures to correctly open the flow restriction valve. It will be appreciated that the top endplate herein can be modified as known in the art, so as to accommodate a flow restriction valve if necessary.

When fuel enters the filter assembly for filtration, the fuel can include water therein in different forms, including free water, e.g. droplets, and emulsified water. Preferably, the first filter media 16 is designed so that free water is initially filtered when fuel enters the filter cartridge from the outside. The first filter media 16 can filter the free water and also coalesce the majority of the emulsified water, and separate the now coalesced water from the fuel. Water, being heavier than fuel, settles down to the bottom of the filter cartridge 10, and drains through the space 40 and opening between the outer portion 39 and the inner portion 37 of the endplate 24. The water is collected in collection area or sump 102 and can be monitored by a water-in-fuel sensor 70. By the time the fuel interfaces with the second filter media 18, most of the water has been separated, and the second filter media 18 performs a final filtration of the fuel before the fuel enters the center of the filter cartridge. The filtered fuel then enters the standpipe 104 and flows to the outlet 108, in a known manner, leading to a downstream protected component, for example a fuel pump (not shown).

With further reference to the filter media 16, 18, the outside of the second filter media 18 generally faces the interior of the first filter media 16. For outside to inside filtration, the inside of the second filter media 18 defines a clean or filtered fuel side of the filter cartridge 10, and the outside of the first filter media 16 defines a dirty or unfiltered fuel side. In appropriate circumstances, the concepts described herein can be applied to inside-out type flow filter cartridges.

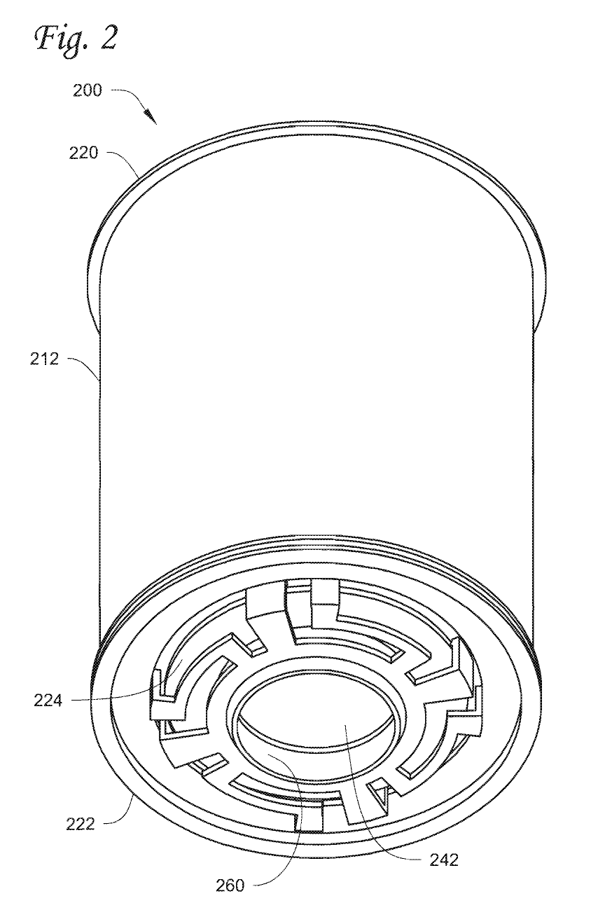

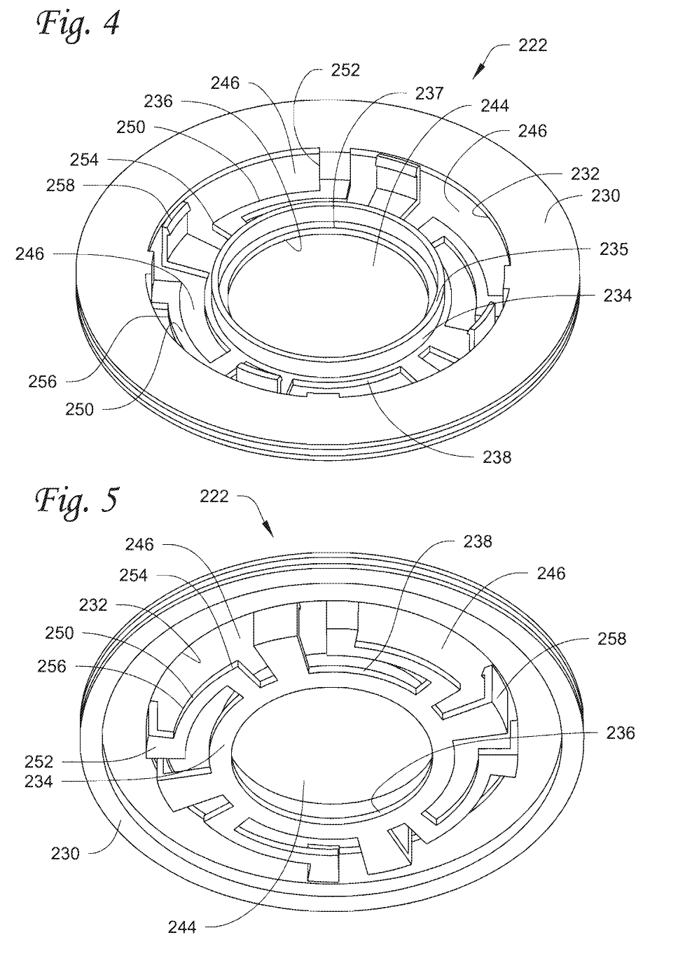

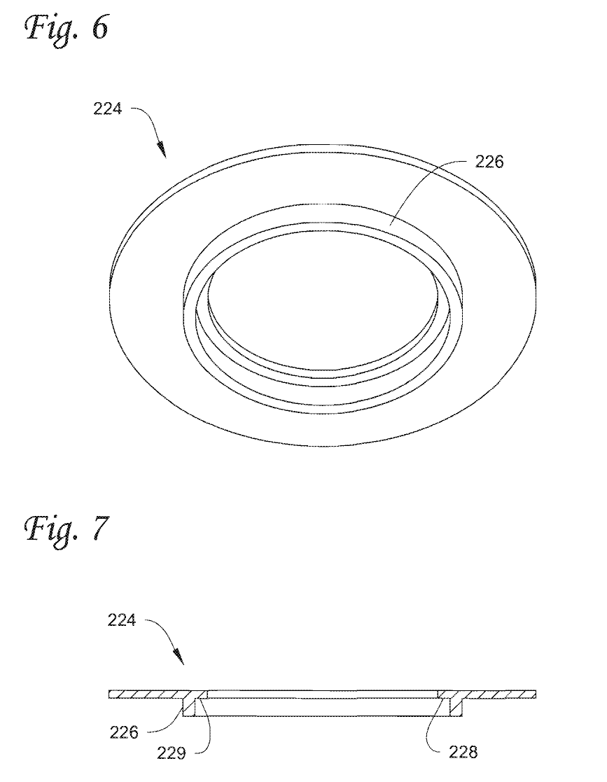

With reference to FIGS. 2-5, another embodiment of a filter cartridge 200 is shown. The filter cartridge 200 is similar to filter cartridge 10 and has similar concepts. The filter cartridge 200 has a slightly modified version of the bottom endplate structure, while showing more specific features thereof.

As with filter cartridge 10, filter cartridge 200 is a filter-in-filter construction including an outer filter 212 and an inner filter 214 concentrically arranged. The cartridge 200 can be designed for outside-in flow, with fuel entering the cartridge 200 from the outside and flows inwardly to the inside of the cartridge 200. The outer filter 212 includes a first generally circular filter media 216 disposed around a central axis. The inner filter 214 includes a second generally circular filter media 218 with an inner diameter defining a generally open area. The filter media 216 and 218 may be composed of various materials and configurations as known in the art. For example, the filter media 216, 218 may be configured as a pleated structure, a chevron pleated structure, or as depth media and be made of paper-like or other fibrous material as known in art. It also will be appreciated that the outer filter 212 and the inner filter 214 may be constructed with center tubes (e.g. center tube 290) such as known in the art to provide additional stability for the filters 212, 214.

As shown, the inner filter 214 is arranged within the central axis of the outer filter 212, such that there is a space 240 between an inner diameter of the outer filter 212 and an outer diameter of the inner filter 214. The generally open area of the inner filter 214 is receivable of a standpipe 104 of a filter housing.

As with the filter cartridge 10, filter cartridge 200 includes an endplate 220 on a top end of each of the outer filter 212 and the inner filter 214. It will be appreciated that the outer filter 212 and the inner filter 214 can each have an endplate at their respective top end, such as may be known in the art.

The outer filter 212 and the inner filter 214 also have an endplate structure 222, 224 on a bottom end of each of the outer filter 212 and the inner filter 214. The endplates 222, 224 can be of a plastic material for example. The endplates 222, 224 are configured to be assembled in a snap fit connection and are slightly modified from the structure shown in FIG. 1.

With further reference to the snap fit connection between the endplates 222, 224, FIGS. 2-5 generally show one embodiment of the snap fit connection through upwardly extending and downwardly extending flanges 235, 226 (discussed below).

The endplate 222 has an outer portion 230 attached to the first filter media 216, and an inner portion 234 substantially surrounded by the outer portion 230. The endplate 222 includes at least one opening 246 between the outer portion 230 and the inner portion 234 in fluid communication with the space 240 between the outer filter 212 and the inner filter 214. In the embodiment shown, there is a plurality of openings 246. The endplate 222 further includes that the inner portion 234 is axially positioned relative to the outer portion 230, such that it is distal to the inner filter 214 and the outer filter 212 relative to the outer portion 230. That is, in the view shown the inner portion 234 is recessed or lower than the outer portion 230. The inner portion 234 further includes an upwardly extending flange 235 that extends toward the filter media 218. As shown, the upwardly extending flange 235 also is axially positioned, so that it is distal to the inner filter 214 and outer filter 212 relative to the outer portion 230.

As particularly shown in the embodiment of FIGS. 2-5, the outer portion 230 is generally ring-shaped with a first radially-inward facing rim 232. The outer portion 230 that is attached to the media 216 is substantially flat and horizontal. The inner portion 234 is substantially surrounded by the outer portion 230. The inner portion 234 is generally ring-shaped and includes a radially-outward facing rim 238 that generally faces the first radially-inward facing rim 232, and a second radially-inward facing rim 236 that defines the opening 242.

The inner portion 234 is flexibly connected to the outer portion 230 so that the inner portion 234 and the outer portion 230 are flexible relative to one another to permit relative movement therebetween. For example, a plurality of resilient arms 250 are connected between the first radially-inward facing rim 232 and the radially-outward facing rim 238. The arms 250 permit relative movements both axially and radially between the inner portion 234 and the outer portion 230. Each arm 250 includes a first end 252 attached to the first radially-inward facing rim 232 and a second end 254 attached to the radially-outward facing rim 238. The first end 252 is attached to the first radially-inward facing rim 232 at a location that is circumferentially offset from the location of attachment of the second end 254 of the respective arm to the radially-outward facing rim 238, thereby creating a circumferential link 256 between the ends 252, 254. The spaces between the arms creates the openings 246 for water drainage between the inner portion 234 and the outer portion 230 to allow water that is separated from the fuel to drain from the filter cartridge 200 into a water collection area (e.g. sump) 102 of a filter housing (e.g. housing 100).

Shoulder tabs 258 may be employed to help with centering the inner filter 214 when it is snapped to the outer filter (see e.g. FIG. 2), and can help restrict movement of the inner filter 214 once assembled to the outer filter 212. In one embodiment, the shoulder tabs 258 are connected to the radially-outward facing rim 238 of the inner portion 234.

The inner portion 234 also includes the axially extending flange 235 that generally extends upwardly from the radially-outward facing rim 238. The flange 235 is generally circular and is spaced from the second radially-inward facing rim 236 to form a ledge 237 that helps support a seal (further described below).

Turning to the endplate 224, the endplate 224 has a segment 228 where the opening 242 extends therethrough. The opening 242 is in fluid communication with the open area of the inner filter 214, which is defined by the inner diameter of the inner filter 214. The opening 242 is aligned with an opening 244 of the outer portion 230, and both openings 242, 244 as illustrated are generally circular in shape for fitting around a generally circular standpipe (e.g. standpipe 104). However, the opening 242 could have other shapes as well for example oval, so as to fit around for example an oval standpipe.

As particularly shown, the endplate 224 includes a generally horizontal and substantially flat portion that is attached to the media 218. The endplate 224 further includes a downwardly extending flange 226 surrounding the opening 242 and extending from the segment 228. The downwardly extending flange 226 extends axially from the segment 22 and is generally a circular flange. The flange 226 helps to form a snap fit connection to connect the flange 226 to the flange 235.

With further reference to the snap fit connection, the endplates 222, 224, as shown are arranged to be engaged to retain the outer filter 212 and inner filter 214 together through the upwardly extending flange 235 and the downwardly extending flange 228. For example, one of the upwardly extending flange 235 and the downwardly extending flange 228 can have a larger or smaller diameter relative to the other of the upwardly extending flange 235 and the downwardly extending flange 228. When connected, either directly or indirectly, the flanges 235, 228 are fitted together in a snapping configuration.

In such an endplate structure as shown, the recessed or axially distal arrangement of the inner portion 234 relative to the outer portion 230 provides a configuration, so that the bottom of the outer filter 212 and the inner filter 214 can reside on substantially the same plane. For example, the bottom of the outer filter 212 and the inner filter 214 are on the same plane with respect to the central axis of the outer filter 212. As with the embodiment of FIG. 1, the outer filter 212 and the inner filter 214 have the same height from the top end to the bottom end. Having the inner filter 214 with at least the same height as the outer filter 212 can provide an overall more efficient filter assembly and that can exploit the most filtration capability from the outer filter 212.

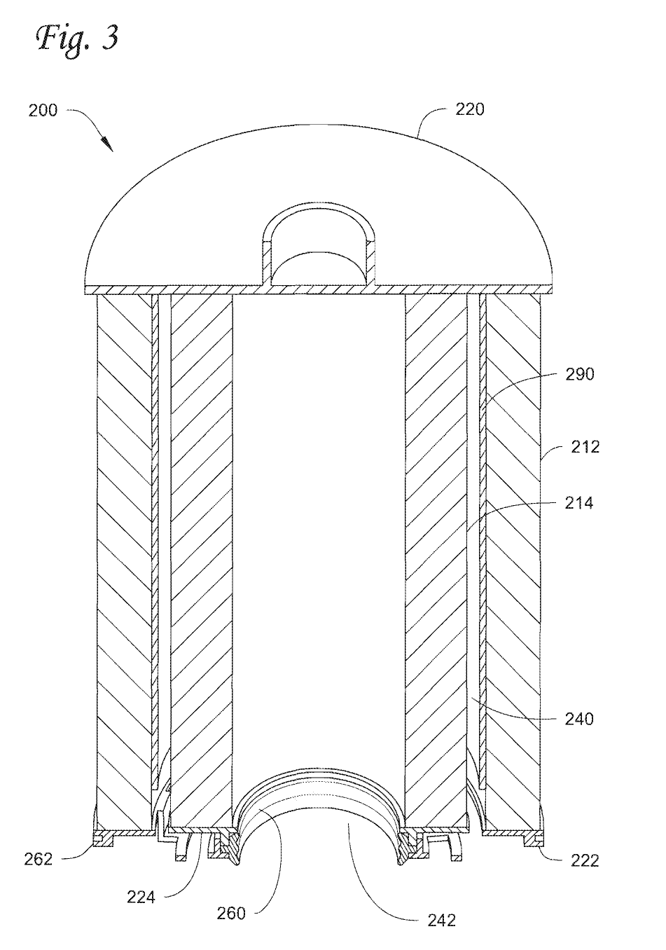

With further reference to the downwardly extending flange 226, the flange 226 extends downwardly from the segment 228 at a location spaced from the perimeter of the opening 242. Therefore, a ledge 229 is created between the flange 226 and the perimeter of the opening 242. As above, the flange 235 of the outer portion is generally circular and is spaced from the second radially-inward facing rim 236 to form a ledge 237 that helps support a seal. When the flange 226 is connected to the flange 235, the ledges 237, 229 define a gasket groove (see e.g. FIG. 3). The gasket groove is configured to receive any suitable gasket to provide an inner sealing surface 260. The inner sealing surface 260 creates as seal with the standpipe 104 of the filter housing 100, so as to prevent fluid leakage between the filter cartridge 200 and the standpipe. In the embodiment shown, flange 226 fits inside the flange 235. If appropriate the flange 235 may fit inside the flange 226.

As specifically shown in FIG. 3, the endplate 222 of the outer filter 212 and the endplate 224 of the inner filter 214 define the gasket groove through an arrangement of the downwardly extending flange 226 of the endplate 224 of the inner filter 214, with the inner portion 234 of the outer filter 212. The inner sealing surface 60 comprises any suitable gasket retained in the gasket groove between the downwardly extending flange 226 and the inner portion 234. As shown for example, the ledges 237, 229 of the flanges 235, 226 help retain the gasket.

With further reference to sealing structures, the endplate 222 includes an outer sealing surface 262 on an outer diameter of the outer filter 212. For example, the endplate 222 may be formed with a groove that can retain any suitable gasket as the sealing surface 262. As shown, the inner sealing surface 260 is on the inner diameter of the inner filter 214.

In operation, the outer sealing surface 262, for example, seals with the inner surface of a filter housing, for example housing 100. The outer sealing surface 262 keeps incoming fuel that has entered through the inlet 106 separated from water that has collected in the sump 102. The inner sealing surface 260 seals with the outer surface of the standpipe 104. The inner sealing surface 260 keeps filtered fuel separated from fuel that has yet to pass the inner filter 214.

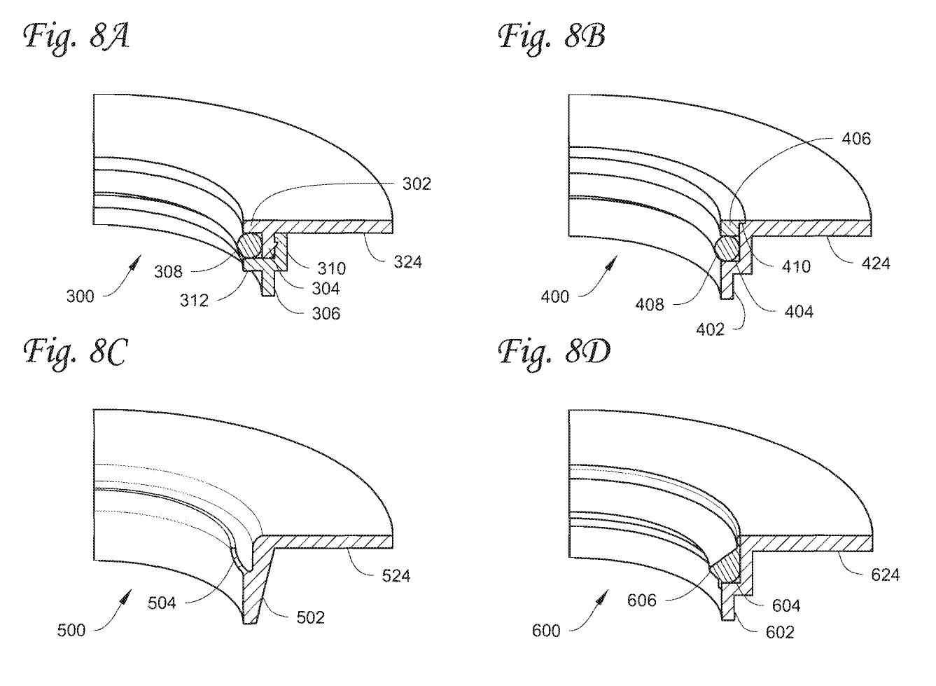

With further reference to sealing configurations, FIGS. 8A-8D show different embodiments for an inner sealing surface. For example, the segment 228 proximate the opening 242 can be modified with various support structures to accommodate different types of seal configurations and sometimes indirectly snap fit the inner filter to the outer filter through such support structures.

FIG. 8A shows a gasket seal configuration 300, such but not limited to an o-ring seal type seal. An endplate similar to endplate 224 has a segment 324 that includes an inner portion 302 proximate the inner diameter and a downwardly extending flange 304 extending from the segment 324. A retainer 306 includes a support 312 extending in a generally parallel direction as the inner portion 302, and a flange 310 extending in a generally parallel direction as the downwardly extending flange 304. The retainer 306 can be snap-fitted to the segment 324, for example through connection of an inner diameter of the flange 310 and an outer diameter of the downwardly extending flange 304. In one embodiment, the outer diameter of the downwardly extending flange 304 is larger than the inner diameter of the flange 310, so as to allow for snap-fit engagement between the retainer 306 and flange 304. The inner portion 302, inner diameter of the support 304, and the support 312 form a groove to allow an o-ring 308 to be retained therein. That is, the retainer 306 is arranged with the segment 324 and the downwardly extending flange 304 to provide the gasket groove to retain the gasket (o-ring 308). The downward flange 310 is adapted for a snap fit connection with the upwardly extending flange (e.g. 235) of the outer filter (e.g. 212) to indirectly snap fit the segment 324 of the endplate on the inner filter with the endplate of the outer filter.

FIG. 8B shows another gasket seal configuration 400, such as but not limited to an o-ring type seal. A retainer 406 retains the o-ring 408 on a segment 424 of an endplate similar to endplate 224. Differently from FIG. 8A, the retainer 406 is disposed on top of the o-ring 408, where the segment 424 has a supporting downward flange 402 extending from the inner diameter. The support flange 402 also includes a step region 404. The step region 404 and the retainer 406 form a groove to retain the o-ring 408. In one embodiment, the step region 404 acts as a groove step along the downward flange 402, where the o-ring 408 is retained between the retainer 406 and step region 404. As also shown in the embodiment of FIG. 8B, the retainer 406 and the segment 424 are fitted at a step area 410. The step 410 is at a junction of the segment 424 and the downward flange 402. In some examples, the retainer 406 is welded with heat during the embedding of the filter media onto the endplate, or by press fitting the retainer 406 onto the endplate.

Thus, the embodiment of FIG. 8B shows a gasket (e.g. o-ring 408) and a retainer 406 that helps retain the gasket to the endplate (e.g. segment 424 and flange 402) of the inner filter. The gasket retainer 406 is arranged with the downward support flange 402 to provide the gasket groove that retains the gasket. The gasket 408 is retained between the retainer 406 and step 404. The downward flange 402 acts as the downwardly extending flange which can snap fit the upwardly extending flange of the endplate of the outer filter.

FIG. 8C shows another seal configuration 500 in the form of a wiper seal 504 on an inner annular flange 502 of the segment 524 of an endplate similar to endplate 224. In the example shown, the inner annular flange 502 extends downward from the inner diameter of the segment 524, and the wiper seal 504 is formed from the inner annular flange 502. In one embodiment, the wiper seal is molded onto an inner diameter of the inner annular flange 502. The wiper seal 504 is a relatively flexible flange that can seal the endplate to a standpipe. The downward flange 502 acts as the downwardly extending flange which can snap fit to the upwardly extending flange of the endplate of the outer filter.

FIG. 8D shows another seal configuration 600 as a modified overmold construction. In some examples, the endplate includes a segment 624 with a support flange 602 extending downward from the inner diameter and has a step 604. An overmold material 606 can be disposed on the step 604 for example by injection molding prior to embedding of the filter media. As shown, the step 604 is disposed along the downward extending flange 602.

It will be appreciated that any of the seal configurations described may also be suitably applied to the outer surface of the endplate of the outer filter as one of skill in the art could accomplish. That is, the outer sealing surface on the outer endplate can have any of a gasket seal, for example an o-ring, overmolded, and molded seals, as well as a wiper seal. Materials for such seals of both the inner and outer sealing surfaces can include, but are not limited to, thermoplastic materials, rubber materials, molded plastic materials.

The filter cartridge described herein can, for example, accommodate filters of generally equal lengths and improve filtration capability and efficiency.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A filter cartridge comprising:
an outer filter that includes first filter media disposed around a central axis, and an endplate connected to an end of the first filter media;
an inner filter that includes second filter media arranged within the central axis of the outer filter, such that there is a space between an inner diameter of the outer filter and an outer diameter of the inner filter, the inner filter having an inner diameter defining an opening adapted for inserting a standpipe of a filter housing therein, the inner filter includes an endplate connected to an end of the second filter media; and
the endplate of the outer filter includes an outer portion attached to the first filter media, an inner portion substantially surrounded by the outer portion, at least one opening between the outer portion and the inner portion, and an opening through the inner portion, the opening between the outer portion and the inner portion is in fluid communication with the space between the outer filter and the inner filter, the inner portion is axially positioned relative to the outer portion and distal to the inner and outer filters relative to the outer portion, the inner portion includes an upwardly extending flange surrounding the opening through the inner portion,
the endplate of the inner filter includes a segment attached to the second filter media, the segment includes an opening in fluid communication with the opening of the inner filter defined by the inner diameter, and a downwardly extending flange surrounding the opening of the segment, and
the endplates of the outer filter and the inner filter are arranged in a snap fit connection through the upwardly extending flange and the downwardly extending flange.

2. The filter cartridge of claim 1, wherein the outer filter and the inner filter have bottom ends that reside on substantially the same plane with respect to the central axis.

3. The filter cartridge of claim 2, wherein the endplate of the outer filter and the endplate of the inner filter are bottom endplates on the bottom ends of the outer and inner filters.

4. The filter cartridge of claim 1, further comprising an outer sealing surface on an outer surface of the endplate of the outer filter, the outer sealing surface is one of a gasket seal including an o-ring or a molded seal, or a wiper flange seal, and
an inner sealing surface on an inner diameter of the inner endplate, the inner sealing surface is one of a gasket seal including an o-ring or a molded seal, or a wiper flange seal.

5. The filter cartridge of claim 1, wherein the inner portion is flexibly connected to the outer portion so that the inner portion and the outer portion are flexible relative to one another to permit relative movements therebetween.

6. The filter cartridge of claim 1, wherein the outer portion comprises a first ring-shaped portion with a first radially-inward facing rim,
the inner portion comprises a second ring-shaped portion disposed within the first ring-shaped portion, the second ring-shaped portion including a radially-outward facing rim that generally faces the first radially-inward facing rim, and a second radially-inward facing rim having the inner diameter that defines the opening of the inner portion, and
a plurality of resilient arms connected between the first radially-inward facing rim and the radially-outward facing rim, the arms permitting relative movement between the second ring-shaped portion and the first ring-shaped portion.

7. The filter cartridge of claim 6, wherein each arm includes a first end attached to the first radially-inward facing rim and a second end attached to the radially-outward facing rim, and the first end of each arm is attached to the first radially-inward facing rim at a location that is circumferentially offset from the location of attachment of the second end of the respective arm to the radially-outward facing rim.

8. The filter cartridge of claim 6, wherein the second ring-shaped portion has the upwardly extending flange thereon, the upwardly extending flange is generally circular and spaced from the second radially-inward facing rim, and the segment of the inner filter has the downwardly extending flange thereon, such that the upwardly extending flange and the downwardly extending flange are engaged in the snap fit connection.

9. The filter cartridge of claim 1, wherein the endplate of the outer filter and the endplate of the inner filter define a gasket groove through an arrangement of the segment of the endplate of the inner filter, with the inner portion of the outer filter, further comprising a gasket retained in the gasket groove between the segment and the inner portion.

10. The filter cartridge of claim 1, wherein the endplate of the outer filter and the endplate of the inner filter define a gasket groove through an arrangement of the downwardly extending flange of the endplate of the inner filter, with the inner portion of the outer filter, further comprising a gasket retained in the gasket groove between the downwardly extending flange and the inner portion.

11. The filter cartridge of claim 1, further comprising a gasket and the endplate of the inner filter further comprising a gasket retainer, the gasket retainer is arranged with the segment and the downwardly extending flange to provide a gasket groove to retain the gasket, the gasket retainer having an upper flange that engages the downwardly extending flange and having a downward flange adapted for a snap fit connection with the upwardly extending flange of the outer filter.

12. The filter cartridge of claim 1, further comprising a gasket and the endplate of the inner filter further comprising a gasket retainer, the gasket retainer is arranged with the downwardly extending flange to provide a gasket groove to retain the gasket, the endplate of the inner filter further comprising a groove step along the downwardly extending flange, the gasket is retained between the gasket retainer and groove step.

13. The filter cartridge of claim 12, further comprising a step at a junction of the segment and the downwardly extending flange, the gasket retainer is fitted to the endplate of the inner filter at the step.

14. The filter cartridge of claim 1, further comprising a wiper seal molded onto an inner diameter of the downwardly extending flange.

15. The filter cartridge of claim 1, further comprising a gasket step along the downwardly extending flange, further comprising an overmold seal on the gasket step.

16. A filter cartridge endplate, comprising:
an outer portion configured for attachment to a first filter media of an outer filter;
an inner portion substantially surrounded by the outer portion, the inner portion is axially positioned so that it is recessed relative to the outer portion, the inner portion includes an upwardly extending flange surrounding the opening through the inner portion,
at least one opening between the outer portion and the inner portion and an opening through the inner portion; and
a segment configured for attachment to a second filter media of an inner filter, the segment includes an opening in fluid communication with the opening through the inner portion, and a downwardly extending flange surrounding the opening of the segment, and
the endplates of the outer filter and the inner filter are arranged in a snap fit connection through the upwardly extending flange and the downwardly extending flange.

17. The filter cartridge endplate of claim 16, wherein the inner portion is substantially surrounded by the outer portion and flexibly connected to the outer portion so that the inner portion and the outer portion are flexible relative to one another to permit relative movement therebetween, the inner portion is configured for attachment to a second filter, and the inner portion includes a central opening.

18. The filter cartridge endplate of claim 16, wherein the outer portion comprises a first ring-shaped portion with a first radially-inward facing rim;
the inner portion comprises a second ring-shaped portion disposed within the first ring-shaped portion, the second ring-shaped portion including a radially-outward facing rim that generally faces the first radially-inward facing rim, and a second radially-inward facing rim that defines the central opening; and
a plurality of resilient arms connected between the first radially-inward facing rim and the radially-outward facing rim, the arms permitting relative movement between the second ring-shaped portion and the first ring-shaped portion.

19. The filter cartridge endplate of claim 18, wherein each arm includes a first end attached to the first radially-inward facing rim and a second end attached to the radially-outward facing rim, and the first end of each arm is attached to the first radially-inward facing rim at a location that is circumferentially offset from the location of attachment of the second end of the respective arm to the radially-outward facing rim.

20. The filter cartridge endplate of claim 16, comprising a plurality of openings in the endplate between the outer portion and the inner portion.
